(19) United States
(12) Patent Application Publication
(10) Pub. No.: US 2013/0301498 A1
(43) Pub. Date: Nov. 14, 2013

(54) SCHEME AND APPARATUS FOR MULTIRAB ENHANCEMENTS WITH KEEPING BOTH CIRCUIT-SWITCHED VOICE CALL AND PACKET-SWITCHED DATA SESSION ALIVE

(71) Applicant: QUALCOMM INCORPORATED, San Diego, CA (US)

(72) Inventors: Sitaramanjaneyulu Kanamarlapudi, San Diego, CA (US); Liangchi Hsu, San Diego, CA (US)

(73) Assignee: QUALCOMM Incorporated, San Diego, CA (US)

(21) Appl. No.: 13/684,721

(22) Filed: Nov. 26, 2012

Related U.S. Application Data
(60) Provisional application No. 61/646,429, filed on May 14, 2012.

(51) Int. Cl. H04W 52/02

(52) U.S. Cl. CPC H04W 52/0225
USPC 370/311

(57) ABSTRACT

Apparatus and methods are described herein for maintaining both a circuit-switched voice call and a packet-switched data session alive during a multi-RAB call. A determination is made as to whether a user equipment (UE) is in a power-limited situation. If it is determined that the UE is in a power-limited situation, one or more operating conditions are adjusted to maintain the multi-RAB call while in the power-limited situation.

### CLAIM OF PRIORITY UNDER 35 U.S.C. §119

The present Application for Patent claims priority to Provisional Application No. 61/646,429 entitled “Scheme and Apparatus for MultiRAB Enhancements with Keeping Both Circuit-Switched Voice Call and Packet-Switched Data Session Alive” filed May 14, 2012, and assigned to the assignee hereof and hereby expressly incorporated by reference herein.

### BACKGROUND

1. Field

Aspects of the present disclosure relate generally to wireless communication systems, and more particularly to maintaining Multiple Radio Access Bearer (multi-RAB) calls when in a power limited situation.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

A radio access bearer (RAB) consists of radio links and radio bearers, as well as core network interface and control. Multi-RAB involves more than one core network. In the case of circuit-switched (CS) and packet-switched (PS) concurrent services, the multi-RAB requires both PS and CS call maintenance simultaneously.

In Multi RAB calls, during the power limited conditions or challenging radio conditions, the traffic on the PS RAB might lead to RLC RESET and eventually RLC Unrecoverable errors. This will lead to CS and PS call drop as per the current standards. There are multiple techniques to limit the data on the PS Call to ensure that, CS call will not be dropped. For example, previous techniques have included limiting the PS traffic whenever non-minimum set transport format combinations (TFCs) are in excess power/Blocked state.

The circuit-switched voice call drop rate is higher in multi-RAB scenario than that in the voice-only call scenario. In the past, there have been mechanisms or enhancements to prolong the CS call lifetime by sacrificing the PS data call.

For multi-RAB calls, to reduce the circuit-switched voice call drop rate, it is helpful to prevent RLC reset for PS call. It is also helpful to reduce unnecessary signaling (i.e. SRB—signaling radio bearer) activity for PS call. There were implementation enhancements to block the PS call or its related signaling procedures. Performance gain was observed because of those enhancements. However, the gain (i.e. CS voice call drop rate) was coming from scarifying the PS data call activity or its data throughput. The PS sacrifice might be tolerable for some specific requirements, but may not be allowed for others.

Thus, improvements in maintaining a multi-RAB call without sacrificing the PS call are needed.

### SUMMARY

In accordance with some aspects of the disclosure, a method for wireless communication is provided. The method includes determining whether a UE is operating in a power-limited situation during a multiple radio access bearer (multi-RAB) call; and upon determining the power-limited situation, adjusting one or more operating conditions to maintain a packet-switched (PS) and a circuit-switched (CS) call during the power-limited situation.

In accordance with some aspects of the disclosure, an apparatus for wireless communication is provided. The apparatus includes means for determining whether a UE is operating in a power-limited situation during a multiple radio access bearer (multi-RAB) call; and upon determining the power-limited situation, means for adjusting one or more operating conditions to maintain a packet-switched (PS) and a circuit-switched (CS) call during the power-limited situation.

In accordance with some aspects of the disclosure, a non-transitory computer-readable medium is provided. The computer-readable medium includes at least one instruction for causing a computer to determine whether a UE is operating in a power-limited situation during a multiple radio access bearer (multi-RAB) call; and at least one instruction for, upon determining the power-limited situation, adjusting one or more operating conditions to maintain a packet-switched (PS) and a circuit-switched (CS) call during the power-limited situation.

In accordance with some aspects of the disclosure, an apparatus for wireless communication is provided. The apparatus includes at least one processor configured to determine whether a UE is operating in a power-limited situation during a multiple radio access bearer (multi-RAB) call; and upon determining the power-limited situation, adjust one or more operating conditions to maintain a packet-switched (PS) and a circuit-switched (CS) call during the power-limited situation. The apparatus also includes a memory coupled to the at least one processor.

These and other aspects of the invention will become more fully understood upon a review of the detailed description, which follows.

### BRIEF DESCRIPTION OF THE DRAWINGS

FIG. 1 is a functional block diagram of a UE configured for multi-RAB communication.

FIG. 2 is a flow chart depicting a method for wireless communication.

FIG. 3 is a diagram illustrating an example of a hardware implementation for an apparatus employing a processing system.

FIG. 4 is a block diagram conceptually illustrating an example of a telecommunications system.

FIG. 5 is a conceptual diagram illustrating an example of an access network.

FIG. 6 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The apparatus and methods described herein relate to maintaining both a circuit-switched voice call and a packet-switched data session alive during a multi-RAB call. As described above, a multi-RAB call requires maintaining both the PS and CS calls simultaneously. However, during power limited conditions, it may be difficult to maintain both calls. The methods and apparatus described herein are configured to maintain the multi-RAB by performing one or more actions to reduce the probability of an RLC unrecoverable error, which results in dropping the CS call, without sacrificing the PS call.

Specifically, the apparatus and methods describe herein determine whether a device, such as a user equipment, are in a power limited condition. For example, determining a power limited condition may include determining that only a minimum amount of transport control formats (minTFCs) are able to be transmitted during the multi-RAB call. Upon determining the power limited condition, adjustments to the operation of the UE can be performed based on, for example, UE and network configuration and traffic/radio conditions.

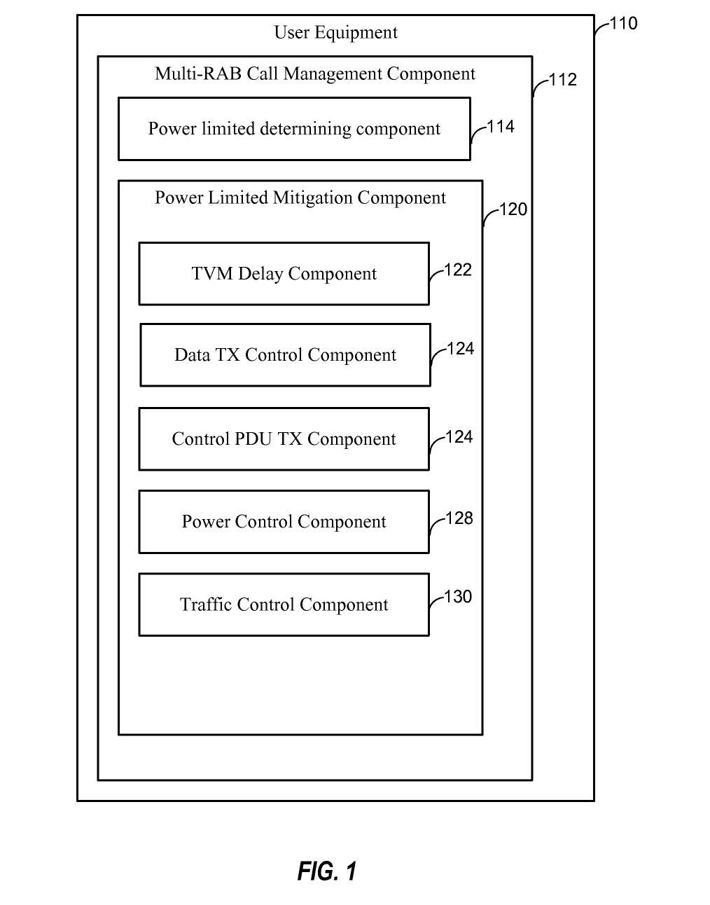

Referring to FIG. 1, a UE 110 configured for multi-RAB communication with one or more network components is illustrated. UE 110 may include a multi-RAB call management component 112 configured to manage call connections during a multi-RAB session. Multi-RAB management component 112 may include a power limited condition determining component 114 configured to detect when UE 110 is experiencing a power limited condition. In one aspect, the power limited condition determining component 114 is configured to detect whether the UE 110 is operating in a multi-RAB minTFC mode. The UE 110 may be configured with a plurality of TFCs. When operating in the minTFC mode, only those mandatory TFCs in a designated minimum set are allowed to be transmitted. Thus, if power limited condition determining component 114 detects that UE 110 is transmitting on the minTFC set, the power limited control determining component 114 may determine that the UE is experiencing a power limited condition, in accordance with some aspects. Other methods of determining a power limited condition may also be applied.

Multi-RAB call management component 112 may also include a power limited condition mitigation component 120 configured to initiate one or more procedures to maintain the multi-RAB session, in spite of the power limited condition being present. Once the power limited determining component 114 has determined that the UE is in a power limited situation, power limited condition mitigation component 120 may initiate one or more procedures for maintaining the call based on, for example, one or more of the UE configuration, network configuration, traffic/radio conditions, and any other conditions.

Power limited condition mitigation component 120 may include a traffic volume measurement (TVM) delay component 122. When a multi-RAB call is in session (both PS and CS calls are active), there are times when there is only a small amount of PS data to be transmitted. Whether or nor TVMs should be transmitted by the UE, and the frequency at which the TVMs should be transmitted, may be configured by the network. TVM delay component 122 may be configured to delay the transmission of TVMs, thereby reducing the number of PDUs transmitted. Delaying transmission of TVMs avoids possible loss of PDUs in the uplink or possible lack of an acknowledgment in the downlink, conditions which, if achieved, would result in an RLC reset. An RLC reset may, in turn, cause an RLC failure and result in a call drop of all of the domains.

Power limited condition mitigating component 120 may also include a data transmission control component 124. Once PS data has been transmitted, an acknowledgement is expected. Typically, if an acknowledgment is not received, the PDU is resent a configured number of times, maxDAT, which is configured by the network. If maxDAT is reached, a reset is then initiated. Data transmission control component 124 is configured to continue transmitting PDUs beyond the maxDAT, giving the network additional time to decode the information when the UE is in a power limited condition, such as the multi-RAB minTFC condition.

Power limited condition mitigating component 120 may also include a control PDU transmission component 126. Typically, there are various triggers that may be configured for transmitting a control PDU in the uplink. For example, a missing PDU indicator option may be configured that causes the UE to send a status PDU only when an expected data is missing. Control PDU transmission component 126 may be configured to keep sending status PDUs, on a periodic basis, on the uplink. The more transmissions sent, the higher the probability of a successful reception by the receiving entity.

Power limited condition mitigating component 120 may also include a power control component 128. The maximum UE transmission power is typically limited by two parameters, the UE power capability rating, and the maximum transmission power allowed by the network. Usually, the transmission power used by the UE is the minimum of the two factors. Here, when in a power limited condition (such as multi-RAB minTFC), power control component 128 may be configured to go beyond the network configured maximum power until the maximum power class allowed by the UE is reached.

In accordance with some aspects, power limited condition mitigating component 120 may also include a traffic control component 130. Traffic control component 130 may be configured to, for example, request that a network component reduce its window size when the UE is in a power limited condition in order to reduce the probability of new transmissions that may cause an RLC reset. For example, the UE may send an RLC WIN SUFI. In some aspects, the traffic control component 130 may be configured to space out the PS traffic in the uplink. For example, rather than transmitting data during every transmission time interval (TTI), component 130 may be configured to transmit every 10 TTI.

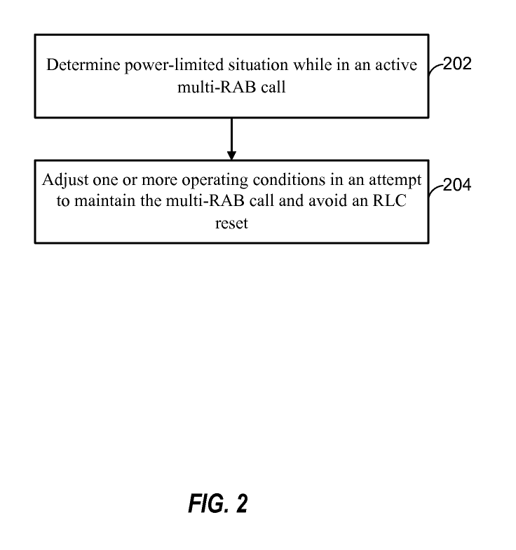

FIG. 2 is a flowchart depicting a method for wireless communications, in accordance with some aspects. The method may be performed, for example, by a UE, such as UE 100 shown in FIG. 1. As shown at 202, the method may begin when the UE determines that it is in a power-limited situation while in an active multi-RAB call. For example, in some aspects, the UE may determine that it is in a power-limited situation upon determining that the UE is in a multi-RAB minTFC condition, wherein only a minimum set of TFC are able to be transmitted.

Upon determining the power-limited situation, the UE may be configured to adjust one or more operating conditions in an attempt to maintain the multi-RAB call and avoid an RLC reset, as shown at 204. The UE may select one or more operating conditions to adjust based on the current operating conditions of the UE. For example, if the UE is configured to transmit TVM reports, and there is very little other PS activity, the UE can determine to delay the transmission of the reports. By delaying the transmission of TVM reports, the UE is able to reduce the likelihood of an RLC reset by reducing UL traffic.

The UE may also determine to transmit data beyond the maxDAT rate configured for the UE. For example, if the maxDAT, which is configured by the network, is set to a low value, continuing to transmit beyond the maxDAT allows an opportunity for the network to receive a transmission without initiating a reset. In some aspects, the UE may determine to transmit additional control/status PDUs in order to increase the odds of the network receiving a transmission. In some aspects, the UE may transmit a power beyond the maximum set by the network, until reaching the maximum transmission power capability of the UE. Other techniques for adjusting the operating conditions may include instructing the network to reduce its window size and/or spacing out PS traffic in the uplink.

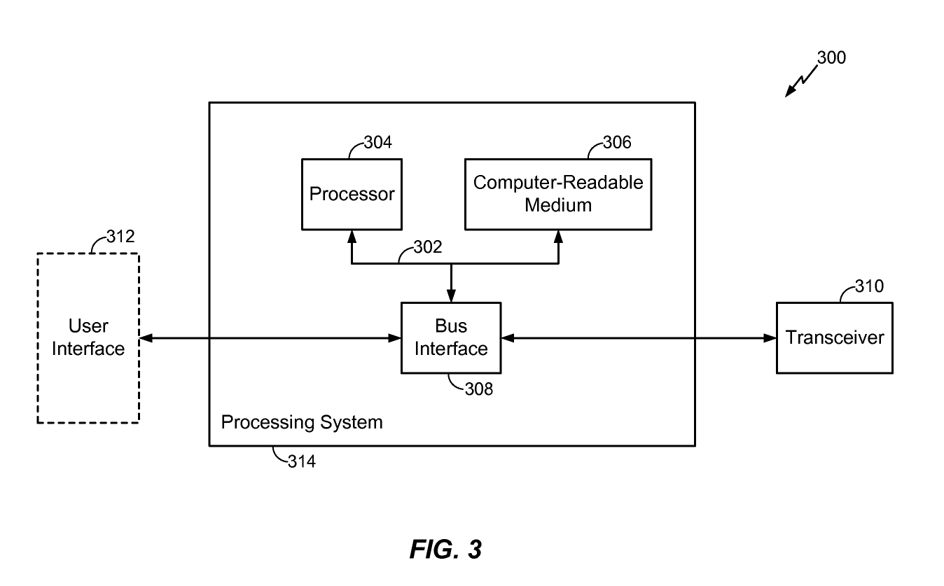

FIG. 3 is a conceptual diagram illustrating an example of a hardware implementation for an apparatus 300 employing a processing system 314. In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors, represented generally by the processor 304, and computer-readable media, represented generally by the computer-readable medium 306. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 32 (e.g., keypad, display, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described infra for any particular apparatus. The computer-readable medium 306 may also be used for storing data that is manipulated by the processor 304 when executing software. UE 110, shown in FIG. 1, may use processing system 314 and/or processor 304 to implement the functions described with respect to FIG. 1.

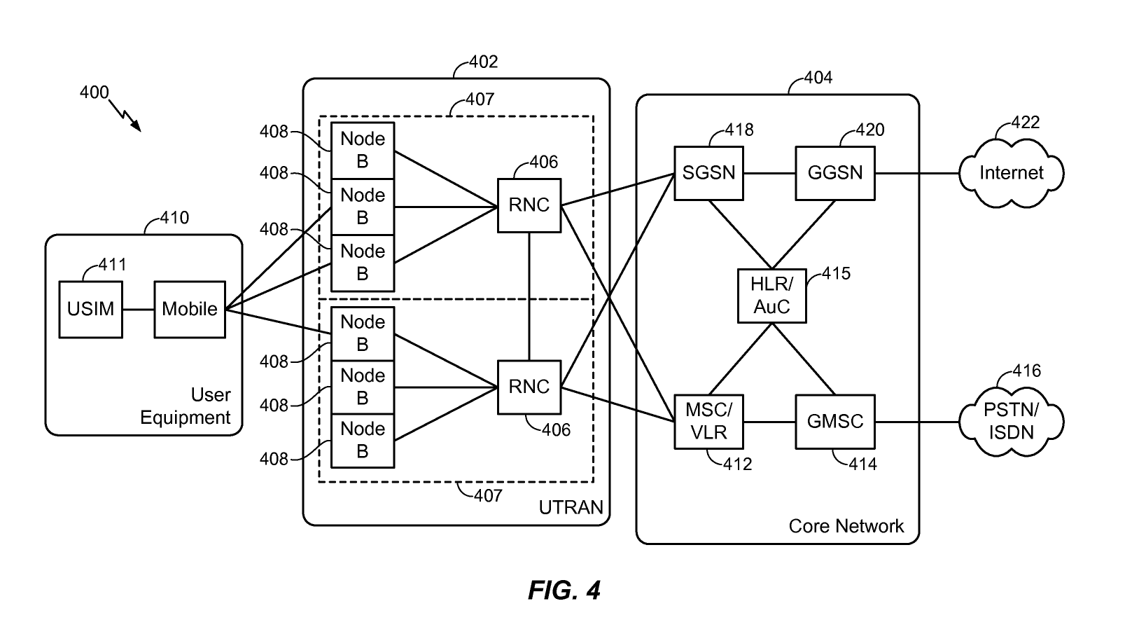

The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system 400 employing a W-CDMA air interface. A UMTS network includes three interacting domains: a Core Network (CN) 404, a UMTS Terrestrial Radio Access Network (UTRAN) 402, and User Equipment (UE) 410. In this example, the UTRAN 402 provides various wireless services including telephony, video, data, messaging, broadcasts, and/or other services. The UTRAN 402 may include a plurality of Radio Network Subsystems (RNSs) such as an RNS 407, each controlled by a respective Radio Network Controller (RNC) such as an RNC 406. Here, the UTRAN 402 may include any number of RNCs 406 and RNSs 407 in addition to the RNCs 406 and RNSs 407 illustrated herein. The RNC 406 is an apparatus responsible for, among other things, assigning, reconfiguring and releasing radio resources within the RNS 407. The RNC 406 may be interconnected to other RNCs (not shown) in the UTRAN 402 through various types of interfaces such as a direct physical connection, a virtual network, or the like, using any suitable transport network.

Communication between a UE 410 and a Node B 408 may be considered as including a physical (PHY) layer and a medium access control (MAC) layer. Further, communication between a UE 410 and an RNC 406 by way of a respective Node B 408 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each SRNS 407; however, the SRNSs 407 may include any number of wireless Node Bs. The Node Bs 408 provide wireless access points to a core network (CN) 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 410 may further include a universal subscriber identity module (USIM) 411, which contains a user's subscription information to a network. For illustrative purposes, one UE 410 is shown in communication with a number of the Node Bs 408. The downlink (DL), also called the forward link, refers to the communication link from a Node B 408 to a UE 410, and the uplink (UL), also called the reverse link, refers to the communication link from a UE 410 to a Node B 408.

The core network 404 interfaces with one or more access networks, such as the UTRAN 402. As shown, the core network 404 is a GSM core network. However, as those skilled in the art will recognize, the various concepts presented throughout this disclosure may be implemented in a RAN, or other suitable access network, to provide UEs with access to types of core networks other than GSM networks.

The core network 404 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 404 supports circuit-switched services with a MSC 412 and a GMSC 414. In some applications, the GMSC 44 may be referred to as a media gateway (MGW). One or more RNCs, such as the RNC 406, may be connected to the MSC 412. The MSC 412 is an apparatus that controls call setup, call routing, and UE mobility functions. The MSC 412 also includes a visitor location register (VLR) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The core network 404 also supports packet-data services with a serving GPRS support node (SGSN) 418 and a gateway GPRS support node (GGSN) 420. GPRS, which stands for General Packet Radio Service, is designed to provide packet-data services at speeds higher than those available with standard circuit-switched data services. The GGSN 420 provides a connection for the UTRAN 402 to a packet-based network 422. The packet-based network 422 may be the Internet, a private data network, or some other suitable packet-based network. The primary function of the GGSN 420 is to provide the UEs 410 with packet-based network connectivity. Data packets may be transferred between the GGSN 420 and the UEs 410 through the SGSN 418, which performs primarily the same functions in the packet-based domain as the MSC 412 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 408 and a UE 410. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

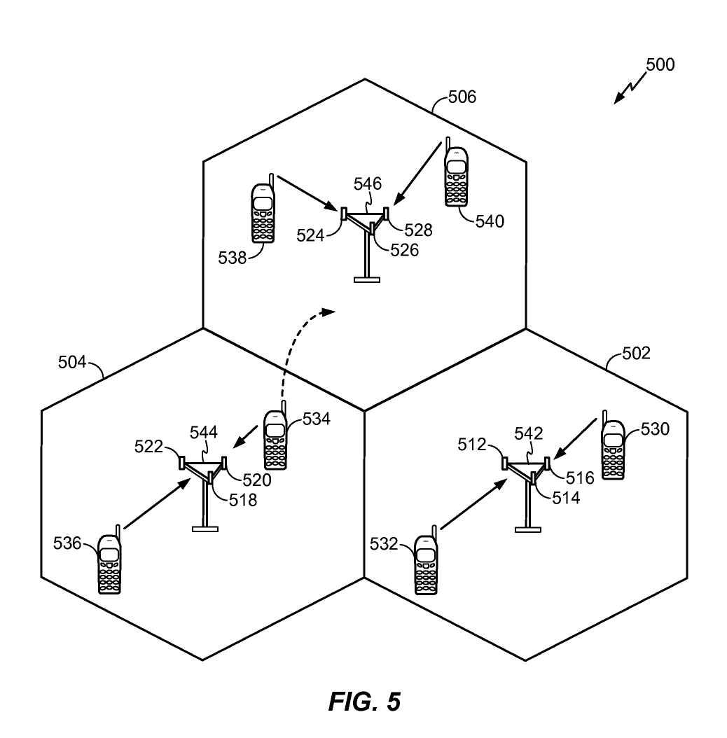

Referring to FIG. 5, an access network 500 in a UTRAN architecture is illustrated. The multiple access wireless communication system includes multiple cellular regions (cells), including cells 502, 504, and 506, each of which may include one or more sectors. The multiple sectors can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector. The cells 502, 504 and 506 may include several wireless communication devices, e.g., User Equipment or UEs, which may be in communication with one or more sectors of each cell 502, 504 or 506. For example, UEs 530 and 532 may be in communication with Node B 542, UEs 534 and 536 may be in communication with Node B 544, and UEs 538 and 540 can be in communication with Node B 546. Here, each Node B 542, 544, 546 is configured to provide an access point to a core network 404 (see FIG. 4) for all the UEs 530, 532, 534, 536, 538, 540 in the respective cells 502, 504, and 506.

As the UE 534 moves from the illustrated location in cell 504 into cell 506, a serving cell change (SCC) or handover may occur in which communication with the UE 534 transitions from the cell 504, which may be referred to as the source cell, to cell 506, which may be referred to as the target cell. Management of the handover procedure may take place at the UE 534, at the Node Bs corresponding to the respective cells, at a radio network controller 406 (see FIG. 4), or at another suitable node in the wireless network. For example, during a call with the source cell 504, or at any other time, the UE 534 may monitor various parameters of the source cell 504 as well as various parameters of neighboring cells such as cells 506 and 502. Further, depending on the quality of these parameters, the UE 534 may maintain communication with one or more of the neighboring cells. During this time, the UE 534 may maintain an Active Set, that is, a list of cells that the UE 534 is simultaneously connected to (i.e., the UTRA cells that are currently assigning a downlink dedicated physical channel DPCH or fractional downlink dedicated physical channel F-DPCH to the UE 534 may constitute the Active Set).

The modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

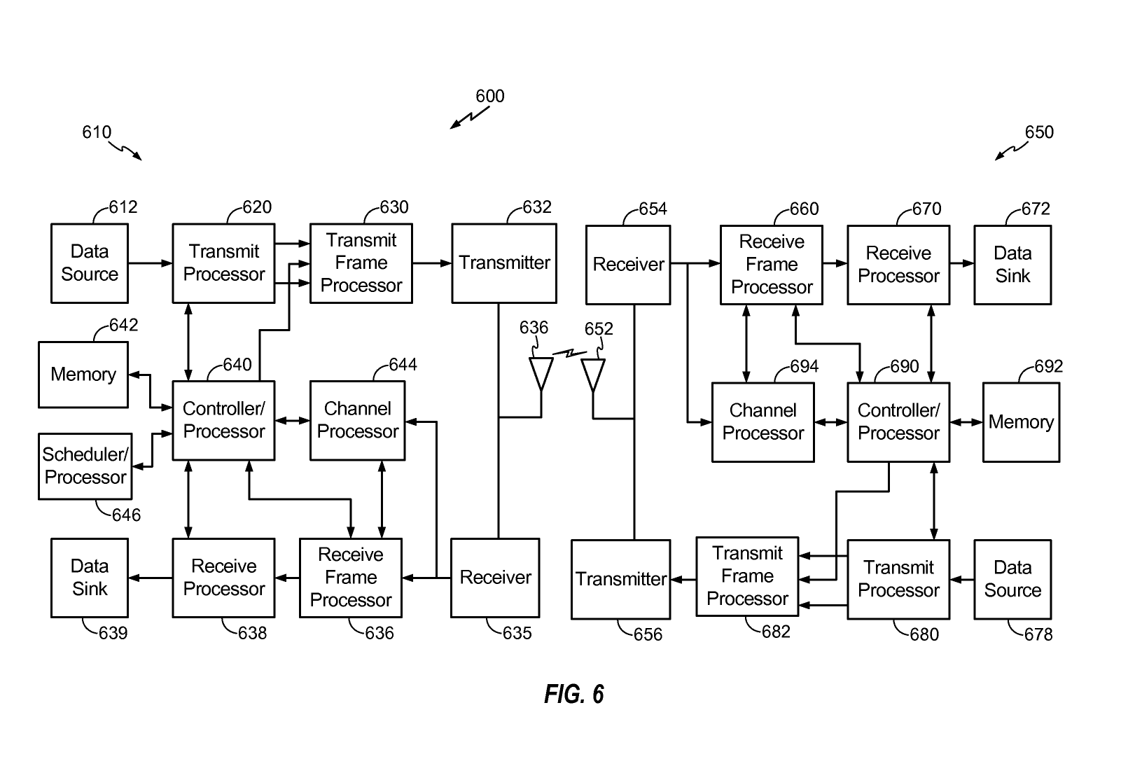

FIG. 6 is a block diagram of a Node B 610 in communication with a UE 650, where the Node B 610 may be the Node B 408 in FIG. 4, and the UE 650 may be the UE 410 in FIG. 4. In the downlink communication, a transmit processor 620 may receive data from a data source 612 and control signals from a controller/processor 640. The transmit processor 620 provides various signal processing functions for the data and control signals, as well as reference signals (e.g., pilot signals). For example, the transmit processor 620 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 644 may be used by a controller/processor 640 to determine the coding, modulation, spreading, and/or scrambling schemes for the transmit processor 620. These channel estimates may be derived from a reference signal transmitted by the UE 650 or from feedback from the UE 650. The symbols generated by the transmit processor 620 are provided to a transmit frame processor 630 to create a frame structure. The transmit frame processor 630 creates this frame structure by multiplexing the symbols with information from the controller/processor 640, resulting in a series of frames. The frames are then provided to a transmitter 632, which provides various signal conditioning functions including amplifying, filtering, and modulating the frames onto a carrier for downlink transmission over the wireless medium through antenna 634. The antenna 634 may include one or more antennas, for example, including beam steering bidirectional adaptive antenna arrays or other similar beam technologies.

At the UE 650, a receiver 654 receives the downlink transmission through an antenna 652 and processes the transmission to recover the information modulated onto the carrier. The information recovered by the receiver 654 is provided to a receive frame processor 660, which parses each frame, and provides information from the frames to a channel processor 694 and the data, control, and reference signals to a receive processor 670. The receive processor 670 then performs the inverse of the processing performed by the transmit processor 620 in the Node B 610. More specifically, the receive processor 670 descrambles and despreads the symbols, and then determines the most likely signal constellation points transmitted by the Node B 610 based on the modulation scheme. These soft decisions may be based on channel estimates computed by the channel processor 694. The soft decisions are then decoded and deinterleaved to recover the data, control, and reference signals. The CRC codes are then checked to determine whether the frames were successfully decoded. The data carried by the successfully decoded frames will then be provided to a data sink 672, which represents applications running in the UE 650 and/or various user interfaces (e.g., display). Control signals carried by successfully decoded frames will be provided to a controller/processor 690. When frames are unsuccessfully decoded by the receiver processor 670, the controller/processor 690 may also use an acknowledgement (ACK) and/or negative acknowledgement (NACK) protocol to support retransmission requests for those frames.

In the uplink, data from a data source 678 and control signals from the controller/processor 690 are provided to a transmit processor 680. The data source 678 may represent applications running in the UE 650 and various user interfaces (e.g., keyboard). Similar to the functionality described in connection with the downlink transmission by the Node B 610, the transmit processor 680 provides various signal processing functions including CRC codes, coding and interleaving to facilitate FEC, mapping to signal constellations, spreading with OVSFs, and scrambling to produce a series of symbols. Channel estimates, derived by the channel processor 694 from a reference signal transmitted by the Node B 610 or from feedback contained in the midamble transmitted by the Node B 610, may be used to select the appropriate coding, modulation, spreading, and/or scrambling schemes. The symbols produced by the transmit processor 680 will be provided to a transmit frame processor 682 to create a frame structure. The transmit frame processor 682 creates this frame structure by multiplexing the symbols with information from the controller/processor 690, resulting in a series of frames. The frames are then provided to a transmitter 656, which provides various signal conditioning functions including amplification, filtering, and modulating the frames onto a carrier for uplink transmission over the wireless medium through the antenna 652.

The uplink transmission is processed at the Node B 610 in a manner similar to that described in connection with the receiver function at the UE 650. A receiver 635 receives the uplink transmission through the antenna 634 and processes the transmission to recover the information modulated onto the carrier. The information recovered by the receiver 635 is provided to a receive frame processor 636, which parses each frame, and provides information from the frames to the channel processor 644 and the data, control, and reference signals to a receive processor 638. The receive processor 638 performs the inverse of the processing performed by the transmit processor 680 in the UE 650. The data and control signals carried by the successfully decoded frames may then be provided to a data sink 639 and the controller/processor, respectively. If some of the frames were unsuccessfully decoded by the receive processor, the controller/processor 640 may also use an acknowledgement (ACK) and/or negative acknowledgement (NACK) protocol to support retransmission requests for those frames.

The controller/processors 640 and 690 may be used to direct the operation at the Node B 610 and the UE 650, respectively. For example, the controller/processors 640 and 690 may provide various functions including timing, peripheral interfaces, voltage regulation, power management, and other control functions. The computer readable media of memories 642 and 692 may store data and software for the Node B 610 and the UE 650, respectively. A scheduler/processor 646 at the Node B 610 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
determining whether a UE is operating in a power-limited situation during a multiple radio access bearer (multi-RAB) call; and
upon determining the power-limited situation, adjusting one or more operating conditions to maintain a packet-switched (PS) and a circuit-switched (CS) call during the power-limited situation.

2. The method of claim 1, wherein determining whether the UE is operating in a power-limited situation comprises:
determining whether a multi-RAB minimum transport format control (minTFC) condition is present for operating the UE.

3. The method of claim 1, further comprising:
determining whether the UE is configured to transmit traffic volume measurement (TVM) reports; and
upon determining that the UE is configured to transmit TVM reports, delaying transmission of the TVM reports.

4. The method of claim 1, further comprising:
determining a maxDAT configured for the UE, the maxDAT representing a maximum number of retransmissions allowed for an acknowledgement mode data PDU; and
upon determining the power limited situation, transmitting beyond the maxDAT.

5. The method of claim 4, further comprising:
continuing to transmit beyond the maxDAT until the CS call is released.

6. The method of claim 1, further comprising:
receiving a trigger to transmit a status PDU; and
periodically transmitting the status PDU.

7. The method of claim 1, further comprising:
determining a maximum power capability associated with the UE;
determining a maximum power configured by a network entity; and
upon determining that the UE is in a power limited situation, transmitting data at a power rating up to the maximum power capability associated with the UE.

8. The method of claim 7, wherein the maximum power capability associated with the UE is higher than the maximum power configured by the network entity.

9. The method of claim 1, further comprising:
upon determining a power limited situation, transmitting message to a network entity requesting the network entity to decrease a transmission window size.

10. The method of claim 1, further comprising:
upon determining a power limited situation, spacing PS traffic in the uplink.

11. The method of claim 1, wherein spacing PS traffic in the uplink comprises transmitting data once every predetermined interval, wherein the predetermined interval comprises one or more transmission time intervals (TTI).

12. An apparatus for wireless communication, comprising:
means for determining whether a UE is operating in a power-limited situation during a multiple radio access bearer (multi-RAB) call; and
upon determining the power-limited situation, means for adjusting one or more operating conditions to maintain a packet-switched (PS) and a circuit-switched (CS) call during the power-limited situation.

13. A non-transitory computer-readable medium comprising:
at least one instruction for causing a computer to determine whether a UE is operating in a power-limited situation during a multiple radio access bearer (multi-RAB) call; and
at least one instruction for causing the computer to, upon determining the power-limited situation, adjust one or more operating conditions to maintain a packet-switched (PS) and a circuit-switched (CS) call during the power-limited situation

14. An apparatus for wireless communication, comprising:
at least one processor configured to:
determine whether a UE is operating in a power-limited situation during a multiple radio access bearer (multi-RAB) call; and
upon determining the power-limited situation, adjust one or more operating conditions to maintain a packet-switched (PS) and a circuit-switched (CS) call during the power-limited situation; and
a memory coupled to the at least one processor.

15. The apparatus of claim 14, wherein the at least one processor is further configured to:
determine whether a multi-RAB minimum transport format control (minTFC) condition is present for operating the UE.

16. The apparatus of claim 14, wherein the at least one processor is further configured to:
determine whether the UE is configured to transmit traffic volume measurement (TVM) reports; and
upon determining that the UE is configured to transmit TVM reports, delay transmission of the TVM reports.

17. The apparatus of claim 14, wherein the at least one processor is further configured to:
determine a maxDAT configured for the UE, the maxDAT representing a maximum number of retransmissions allowed for an acknowledgement mode data PDU; and
upon determining the power limited situation, transmit beyond the maxDAT.

18. The apparatus of claim 17, wherein the at least one processor is further configured to:
continue to transmit beyond the maxDAT until the CS call is released.

19. The apparatus of claim 14, wherein the at least one processor is further configured to:
receive a trigger to transmit a status PDU; and
periodically transmit the status PDU.

20. The apparatus of claim 14, wherein the at least one processor is further configured to:
determine a maximum power capability associated with the UE;
determine a maximum power configured by a network entity; and
upon determining that the UE is in a power limited situation, transmit data at a power rating up to the maximum power capability associated with the UE.

21. The apparatus of claim 20, wherein the maximum power capability associated with the UE is higher than the maximum power configured by the network entity.

22. The apparatus of claim 14, wherein the at least one processor is further configured to:
upon determining a power limited situation, transmit message to a network entity requesting the network entity to decrease a transmission window size.

23. The apparatus of claim 14, wherein the at least one processor is further configured to:
upon determining a power limited situation, space PS traffic in the uplink.

24. The apparatus of claim 14, wherein spacing PS traffic in the uplink comprises transmitting data once every predetermined interval, wherein the predetermined interval comprises one or more transmission time intervals (TTI).
